(19) United States
(12) Patent Application Publication
(10) Pub. No.: US 2026/0243571 A1
(43) Pub. Date: Aug. 20, 2026

(54) COLD-ATOM AND LIGHT-PULSE INTERFEROMETRIC SYSTEM AND METHOD, FOR THE ON-BOARD MEASUREMENT OF ACCELERATION OR ROTATION

(71) Applicants: EXAIL, SAINT-GERMAIN-EN-LAYE (FR); INSTITUT D'OPTIQUE THEORIQUE ET APPLIQUÉE, PALAISEAU (FR); CENTRE NATIONAL DE LA RECHERCHE SCIENTIFIQUE, PARIS (FR); UNIVERSITE DE BORDEAUX, BORDEAUX (FR)

(72) Inventors: Quentin D'ARMAGNAC DE CASTANET, SAINT-GERMAIN-EN-LAYE (FR); Simon TEMPLIER, SAINT-GERMAIN-EN-LAYE (FR); Romain ARGUEL, TALENCE (FR); Baptiste BATTELIER, TALENCE (FR)

(21) Appl. No.: 18/853,597

(22) PCT Filed: Apr. 3, 2023
(86) PCT No.: PCT/EP2023/058657

§ 371 Date: Oct. 2, 2024

(30) Foreign Application Priority Data
Apr. 4, 2022 (FR) FR2203057

(51) Int. Cl. G01C 19/72

(52) U.S. Cl. CPC G01C 19/721

(57) ABSTRACT

The invention relates to a cold-atom and light-pulse interferometric system (100) comprising a vacuum chamber (7) containing a cloud of cold atoms (8), a plane retro-reflective optical component (5), a laser source (6) suitable for generating a sequence of laser pulses, and a detection system (17) able to perform an inertial measurement by atom interferometry.

According to the invention, the interferometric system (100) comprises an actuating device (13) that mechanically connects the optical component (5) to a plate (4), and a rotation sensor (1, 2) which is suitable for providing a measurement of the rotation of the vacuum chamber (7) about an axis transverse to the axis of the laser at each interrogation time in said sequence, the actuating device (13) being able to angularly incline the optical component (5) relative to said plate (4) during each interrogation time in said sequence on the basis of said rotation measurement.

### TECHNICAL FIELD

The present invention relates to the technical field of inertial sensors based on an atom interferometer for acceleration and/or rotation measurements.

More particularly, it relates to an inertial sensor based on an atom interferometer for acceleration, gravity and/or rotation measurements about a measurement axis, these measurements being corrected for the rotations of the inertial sensor.

More particularly, it relates to an inertial acceleration, rotation sensor, based in particular on an atom interferometer. This inertial sensor finds applications in an atom gravimeter or gradiometer, or in an on-board inertial navigation system for mobile application, or in geophysics applications or fundamental physics tests.

### PRIOR ART

Over the last twenty years, atom interferometry techniques have enabled development of new measuring instruments, such as gravimeters, gradiometers, accelerometers, gyroscopes, atom clocks and electro-magnetic field sensors.

An atom interferometer combines optical and atomic technologies. More precisely, a cold-atom interferometer is a system in which matter waves propagate along spatially separated paths that delimit a closed surface. An atom interferometer is sensitive to the inertial effects such as accelerations and rotations.

On the one hand, an atom interferometer comprises a source of atoms and a trap for cold atoms configured to generate a cloud of atoms. On the other hand, the atom interferometer comprises a laser source emitting a sequence of interrogation laser pulses intended to interact with the fine structure of the atoms by transfer of photons.

The atom interferometer systems have a sensitivity higher by several orders of magnitude than that of the conventional mechanical sensors. However, these atom interferometry systems are faced with limitations in terms of robustness to tilts and vibrations. On the other hand, the atom interferometry systems have today a reduce range of sensitivity (or dynamic range) compared with the conventional sensors.

Depending on the orientation of the source of atoms and of the atom interferometer, it is possible to measure acceleration and/or rotation in a determined direction. Atom interferometers allow extremely accurate measurements. Atom interferometers find applications in inertial sensors such as cold-atom gravimeters, gradiometers, accelerometers and gyrometers.

A particularly important application of atom interferometry relates to the cold-atom accelerometers (CAA). Most of the cold-atom accelerometers (CAA) are built in a gravimeter configuration, the purpose of which is to measure gravitational acceleration as accurately as possible. The measurement axis of an atom interferometer is defined by the normal to the surface of a retro-reflective mirror arranged in such a way as to reflect the interrogation field towards the cloud of cold atoms. The retro-reflective mirror thus determines a reference frame for the cold-atom inertial sensor. In the case of a gravimeter or gradiometer, this normal is aligned with the vertical direction. These cold-atom interferometers are critically based on this reference frame.

In mobile applications, for example for inertial navigation, different factors mainly limit the operation and performances of cold-atom accelerometers. Firstly, the interferometer no longer functions when its orientation varies randomly, or its movements are random. Indeed, the inertial system movements affect the stability of the reflective surface. On the other hand, in the case of a gravimeter or gradiometer, a misalignment between the normal to the mirror and the local vertical axis introduces a systematic measurement error. These questions are of technical nature and result from the use of the cold-atom inertial sensors outside their nominal operating range.

In particular, a loss of contrast C of the atom interferometry fringes is observed. This loss of contrast causes a loss in the atom interferometer sensitivity. If the contrast C decreases significantly, the interferometer will no longer function. However, this loss of contrast may have different causes.

Publications Shau-Yu Lan et al. “Influence of the Coriolis Force in Atom Interferometry”, PRL 108, 090402 (2012) and Alex Sugarbaker et al. “Enhanced Atom Interferometer Readout through the Application of Phase Shear”, PRL 111, 113002 (2013) describe a cold-atom interferometer (or CAI) used to carry out high-sensitivity inertial measurements (gyrocompass, or gravity gradient measurement) in which a tilting plate is used to compensate for the earth rotation. Although those systems are efficient for stable experiences in laboratory, they are not suitable for on-board inertial measurement applications in which the movements undergone are unpredictable.

Publication Yuan Zhao et al. “Extension of the rotation-rate measurement range with no sensitivity loss in a cold-atom gyroscope”, Phys Rev A, 104.013312 (2021) describes a cold-atom gyroscope mounted horizontally on a vertical axis rotating table and based on three spatially separated Raman pulses to interrogate two counter-propagating clouds of atoms. All the beams are reflected by a same mirror, mounted on a tilting plate to compensate for the rotation of the table and makes it possible to compensate for the loss of contrast. This system is efficient for a horizontal configuration with atoms moving orthogonally to the beams, in which the table rotation signal also controls the plate tilting.

However, these cold-atom interferometer systems are not suitable for mobile operation, where the system is highly integrated so that it can be carried on board a mobile vehicle and remains subject to unpredictably variable vibrations, accelerations and rotations in several directions.

One of the objects of the invention is to propose a cold-atom interferometer system corrected for the above-mentioned drawbacks. In particular, the invention proposes a cold-atom interferometer system that can be used outside its nominal operating range, offering both very high sensitivity and high measurement accuracy over a wide measurement range.

### DISCLOSURE OF THE INVENTION

In order to remedy the above-mentioned drawbacks of the state of the art, the present disclosure proposes a cold-atom and light-pulse interferometric system, the interferometric system comprising a vacuum chamber, a laser source fixed with respect to the vacuum chamber, a plane retro-reflective optical component, an electronic system and a detection system, the vacuum chamber being adapted to contain a cloud of cold atoms, the laser source being adapted to generate a sequence of laser pulses towards the cloud of cold atoms along an axis of the laser, the retro-reflective optical component being arranged so as to reflect the sequence of laser pulses towards the cloud of cold atoms, the sequence of laser pulses comprising N successive light pulses, where N is an integer number higher than or equal to three, the successive light pulses of the sequence being temporally separated from each other by an interrogation time T; the retro-reflective optical component having a normal to its plane defining a measurement axis aligned with the laser axis at an initial time instant of the sequence; the electronic system and the detection system being configured to carry out an inertial measurement of the cloud of atoms, by atom interferometry, along the measurement axis, the inertial measurement being integrated over the sequence of laser pulses.

According to the invention, the interferometric system includes an actuating device mechanically connecting the optical component to a plate, the plate being fixed with respect to the vacuum chamber, and at least one rotation sensor fixed with respect to the vacuum chamber, the at least one rotation sensor and the electronic system being suitable to provide at least one measurement of rotation of the vacuum chamber about at least one axis transverse to the laser axis at each interrogation time of said sequence, the electronic system and the actuating device being adapted to angularly tilt the optical component with respect to said plate during each interrogation time of said sequence, as a function of said at least one rotation measurement acquired by the rotation sensor during said interrogation time of said sequence, in order to compensate for a rotation of the vacuum chamber transversely to the laser axis at each successive light pulse of the sequence with respect to an orientation of the vacuum chamber at the initial time instant of the sequence.

Advantageously, the electronic system is adapted to adjust an optical phase of the laser source emitting the pulse sequence as a function of a measurement of the Coriolis acceleration induced by a compensating rotation of the optical component.

According to a particular aspect, the actuating device comprises a first actuator adapted to tilt the optical component with respect to said plate about a rotation axis transverse to the laser axis and/or a second actuator adapted to tilt the optical component with respect to said plate about another rotation axis transverse to the laser axis.

Especially and advantageously, the at least one rotation sensor comprises a first gyroscope adapted to acquire a measurement of the rotation rate of the vacuum chamber about a first axis transverse to the laser axis and/or a second gyroscope adapted to acquire a measurement of the rotation rate of the vacuum chamber about a second axis transverse to the laser axis.

According to a particular and advantageous embodiment, the first gyroscope is a fiber-optic gyroscope, and the second gyroscope is a fiber-optic gyroscope.

Advantageously, each fiber-optic gyroscope has a sensitivity of at least 1 urad/s/VHz.

Preferably, the first actuator and the second actuator are configured to tilt the plate with an angular resolution lower than 1 prad.

Especially and advantageously, the interrogation time is between 1 ms and several seconds, the first gyroscope and the second gyroscope being configured to acquire the rotation measurement, e.g. an acquisition rate of between 100 Hz and several kHz.

According to a particular aspect, the interferometric system comprises a conventional sensor, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer attached to the plate adapted to acquire a measurement of acceleration of the plate along the measurement axis or the laser axis, and the electronic system is adapted to hybridize the measurements of the conventional sensor with the measurements of the interferometric system.

Advantageously, the conventional sensor comprises a third gyroscope adapted to acquire a measurement of the rotation rate of the plate about the laser axis.

Advantageously, the inertial measurement by atom interferometry is adapted to measure an acceleration and/or a rotation of the vacuum chamber.

The present disclosure also relates to a cold-atom and light-pulse interferometry method comprising the following steps: generating a sequence of laser pulses towards a cloud of cold atoms in a vacuum chamber, the sequence of laser pulses comprising N successive laser pulses, where N is an integer number higher than or equal to three, the successive light pulses of the sequence being timely separated by an interrogation time T, the light pulses being reflected on a retro-reflective optical component, a normal to the plane of the retro-reflective optical component defining a measurement axis and being aligned to the laser axis at an initial time instant of the sequence; at the end of the sequence of laser pulses, carrying out an inertial measurement of the cloud of atoms, by atom interferometry, along the measurement axis, the inertial measurement being integrated during the sequence of laser pulses; measuring at least a rotation of the vacuum chamber about at least one axis transverse to the laser axis at each interrogation time of said sequence; at each interrogation time, angularly tilting the optical component with respect to the vacuum chamber, as a function of the rotation measured during said interrogation time of said sequence, in order to compensate for a rotation of the vacuum chamber transversely to the laser axis at each successive light pulse of the sequence with respect to an orientation of the vacuum chamber at the initial time instant of the sequence.

Advantageously, the rotation measurement comprises a rotation rate measurement that is integrated as a function of time to determine a measurement of rotation angle of the chamber over a specified time interval.

Particularly advantageously, the method comprises the following steps: acquiring a measurement of the Coriolis acceleration induced by a residual rotation of the mirror, resulting from the rotation of the chamber minus the compensation rotation of the optical component and adjusting an optical phase of the laser source emitting the sequence of pulses to compensate for the Coriolis acceleration measurement.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 schematically shows a cold-atom interferometer according to an embodiment of the present disclosure;

FIG. 2 schematically shows the operation of a cold-atom interferometer according to an embodiment of the present disclosure;

FIG. 3 schematically shows simulated fringe contrast curves for a cold-atom interferometer as a function of an uncompensated rotation rate, and for different interrogation durations, in an inertial navigation application;

FIG. 4 schematically shows simulated fringe contrast curves for a cold-atom interferometer as a function of an uncompensated rotation rate, and for different interrogation durations, in a spatial application;

FIG. 5 schematically shows a cold-atom interferometer subjected to an uncompensated rotation of its measurement axis and shows the trajectories of the wave packets during a conventional three-laser pulse sequence of interrogation;

FIG. 6 schematically shows, in a perspective view, the trajectories of the wave packets during a conventional three-laser pulse sequence of interrogation in a cold-atom interferometer subjected to an uncompensated rotation transverse to its measurement axis;

FIG. 7 schematically shows a three-laser pulse sequence of interrogation and indicates rotation rate measurements acquired by a gyroscope between each of the successive light pulses of the sequence;

FIG. 8 schematically shows the same sequence of interrogation as in FIG. 7, in which the rotation rate measurements are integrated as a function of time to provide, in real time, measurements of rotation angle of the interferometer measurement axis during the sequence and tilt angle set points to the mirror;

FIG. 9 schematically shows a cold-atom interferometer in which a rotation transverse to its measurement axis is corrected and shows the trajectories of the wave packets during a three-laser pulse sequence of interrogation;

FIG. 10 schematically shows, in a 3D view, the trajectories of the wave packets during a three-laser pulse sequence of interrogation in a cold-atom interferometer corrected for a rotation transverse to its measurement axis.

It is to be noted that, in these figures, the structural and/or functional elements common to the different alternatives can have the same references numbers.

### DETAILED DESCRIPTION

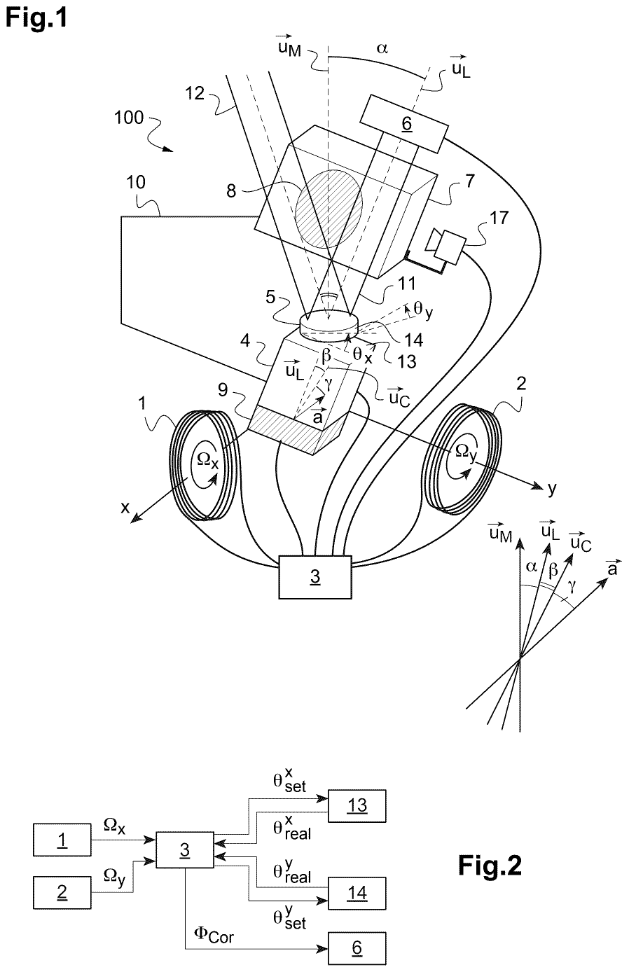

FIG. 1 schematically shows a cold-atom and light-pulse interferometric system 100 according to an embodiment. As known, the cold-atom interferometric system 100 includes a source of atoms and a trap for cold atoms configured to generate and trap a cloud of cold atoms 8. Generally, alkali atoms are used, such as atoms of caesium (Cs), rubidium (Rb) and/or potassium (K). By way of example, the patent document WO2018/154254 A1 describes an atom interferometer. The cloud of cold atoms 8 is confined inside a vacuum chamber 7 or experimental chamber. In applications to an accelerometer or a gravimeter, the cloud of cold atoms 8 has a zero initial speed. In an application to an atom gyrometer, the laser beams of the trap are adapted to launch the cloud of cold atoms 8 along a specified initial direction of propagation, with an initial speed. In an inertial navigation application, the vacuum chamber is carried on board a mobile vehicle.

On other hand, the interferometric system 100 comprises a laser source 6, a plane retro-reflective optical component 5 and a detection system 17. The laser source 6 and the detection system 17 are fixed with respect to the experimental chamber 7. Advantageously, the plane retro-reflective optical component 5 is a mirror, as illustrated in FIG. 1. As an alternative, the plane retro-reflective optical component 5 is a two-dimensional diffraction grating as described in the patent document FR 3109221. The normal to the surface of the plane retro-reflective optical component 5 is aligned with the measurement axis of the atom interferometer that is denoted \vec{u_{M}}. The laser source 6 emits a laser beam 11. A collimator collimates the laser beam 11. The retro-reflective optical component 5 receives the laser beam 11 and forms a reflected laser beam 12. The laser beam 11, respectively the reflected laser beam 12, propagates with a wave vector k₁, respectively k₂. In vector format, the measurement axis \vec{u_{M}} is defined by the vector \vec{k_{eff}}=\vec{k₁}−\vec{k₂}. Thus, the wave vector k_{eff} of the measurement axis is always aligned with the axis normal to the plane of the mirror 5. The experimental chamber 7 is provided with a window to let through the laser beam 11 emitted by the laser source 6.

The axis of the laser source 6 or laser axis is denoted \vec{u_{L}}. The laser axis is defined by the optical collimator that is integral with the experimental chamber. The laser axis is fixed in the reference frame of the experimental chamber 7.

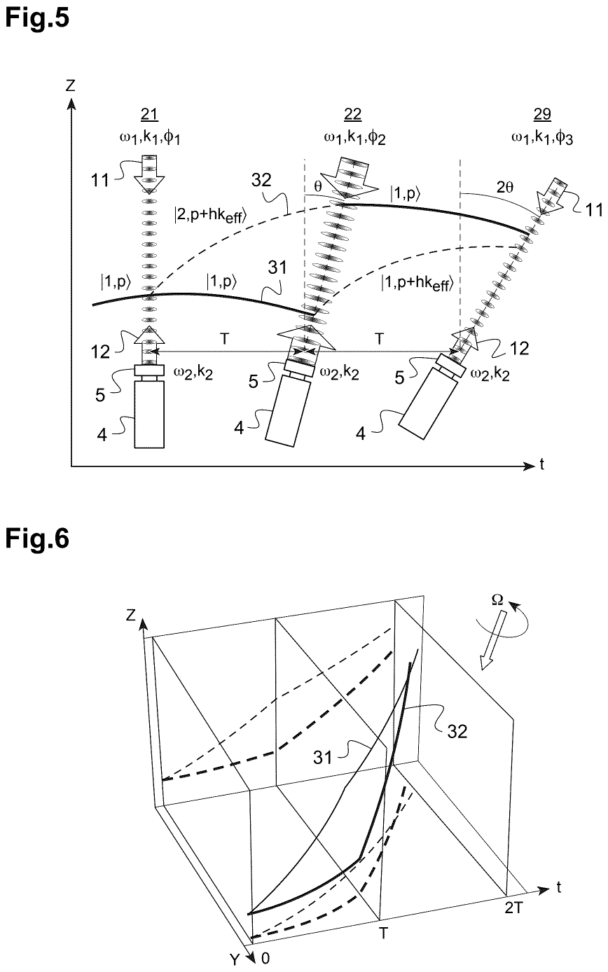

As known, an atom interferometry measurement is based on the emission of a sequence of laser pulses. The successive light pulses of a sequence are generally temporally spaced apart by an interrogation duration T or interrogation time. Generally, a sequence of three light pulses, called “π/2−π−π/2” sequence, is used, as illustrated for example in FIGS. 5 to 10. Pulses “π/2” of duration equal to t make it possible to split or recombine the matter waves associated with the atoms. Pulses “π” of duration equal to 2 τ make it possible to deflect the matter waves. Other sequences comprising more than three pulses are also used, in particular a sequence of four light pulses, “π/2−π−π−π/2”. In any case, a first light pulse 21 interacts with the cloud of cold atoms 8 so as to spatially split the wave associated with each atom into a first wave of atoms 31 travelling along a first path and, respectively, a second wave of atoms 32 travelling along a second path. At least a second light pulse 22 interacts with the two split waves of atoms 31, 32 to redirect them. Finally, a last light pulse 29 spatially recombines the two waves of atoms 31, 32. The surface area defined by the paths of the two waves of atoms 31, 32 between the splitting and the recombination defines an atom interferometry surface area. The sensitivity of the atom interferometer is generally proportional to the surface area delimited by the two paths. The detection system 17 makes it possible to measure the atom interferometry phase shift accumulated between the two waves of atoms 31, 32 along their respective paths between their splitting and their recombination. The detection system 17 is pointed to the centre of the chamber, towards the cloud of atoms 8, by maximizing the field observed. The detection system 17 records a fluorescence signal isotropically emitted by the atoms. The detection system 17 is mechanically integral with the experimental chamber 7 and thus with the collimator defining the laser axis. Advantageously, the detection system records an average over the whole cloud of atoms 8.

On the one hand, an inertial reference frame or absolute inertial reference frame is defined, which is external to the interferometric system 100. This inertial reference frame is fixed with respect to the room, the laboratory, or with respect to a geocentric reference frame, in which is located the atom interferometer carried, for example, on board a mobile vehicle. The orientation of the chamber 7 and the position of the mirror 5 at an initial time t₀=0 for each sequence of laser pulses with respect to the inertial reference frame are known.

On the other hand, a moving reference frame or rotating reference frame, or also inertial frame of reference is defined, which moves with the chamber 7 during the interferometry sequence. The experimental chamber 7 defines the rotating reference frame with respect to the inertial reference frame. The rotating reference frame is defined by the laser axis \vec{u_{L}} and by two axes transverse to the laser axis, e.g. axes X and Y. The detection system 17 of the measurement signal is integral with the experimental chamber 7 and thus with the rotating reference frame. The atom interferometry measurements are carried out in the rotating reference frame. The normal to the mirror 5 is aligned on the laser axis at an initial time t₀=0.

The inertial reference frame is not linked to the rotating reference frame. The inertial reference frame undergoes no inertial effects such as acceleration or rotation of the mobile, contrary to the rotating reference frame.

Initially, i.e. at the beginning of each interferometry sequence, the laser axis \vec{u_{L}} and the measurement axis \vec{u_{M}} of the atom interferometer are aligned with each other, or in other words, the angle α between the laser axis \vec{u_{L}} and the measurement axis \vec{u_{M}} is zero. In an interferometric system with no rotation compensation, the laser axis and the measurement axis remain aligned with each other during the whole interferometry sequence. According to the present disclosure, as described in detail hereinafter, a rotation is applied to the mirror 5 during each interrogation time between two successive light pulses of a same interferometry sequence to compensate for a rotation of the experimental chamber accumulated over the whole duration of interrogation with respect to the inertial reference frame. The rotation applied to the mirror causes a misalignment between the laser axis \vec{u_{L}} and the measurement axis \vec{u_{M}} during the interferometry sequence. Therefore, the angle α may vary during an interferometry measurement. At the end of each interferometry sequence, the normal to the optical component 5 is realigned with the laser axis 6 to return to its initial position.

The interferometric system 100 includes a detection system 17 for detecting an inertial measurement signal by atom interferometry relating to the inertial frame of reference. According to various alternatives, the detection system 17 may be arranged inside or outside the experimental chamber 7. The detection system 17 includes a point detector that detects all the atoms. As an alternative, the detection system 17 includes a camera that forms an image of the overlap of both clouds of atoms and makes it possible to observe spatially resolved interferometric fringes. Generally, the detection system 17 detects, e.g. by fluorescence, a signal representing the quantum state of the atoms after recombination of the two clouds of atoms at the end of the interferometry sequence, as described in the patent document WO 2019/102157 A1. For example, the reading of the interference state of the atoms is done in two stages, using two new reading laser pulses. The first reading laser pulse is adjusted in wavelength on one of the atom states. A photodetector detects a fluorescence signal that results from the absorption of this reading laser pulse. A second reading laser pulse makes it possible to measure a global fluorescence signal to determine the total number of atoms. The two successive measurements give information about the relative state of interference between atoms. The detection of two populations of atoms (on one of the states and the total population) gives a ratio that is then plotted as a function of this atomic phase shift in order to observe interferometric fringes.

The interferometric system 100 also comprises an electronic system 3, for example of the FPGA (“Field Programmable Gate Array”) type. As detailed hereinafter, the electronic system 3 drives and controls the different elements of the interferometric system 100, such as the sequence of laser pulses and the orientation of the optical component 5. Moreover, the electronic system 3 receives the signals from the detection system 17 of the atom interferometer and from different sensors 1, 2 and/or 9, in order to process them to apply a counter-reaction to certain elements and to extract therefrom very-high accuracy atom interferometry measurements.

As indicated in the technological back-ground, in mobile applications, for example in the spatial or inertial navigation field, the acceleration and/or rotation movements undergone by the interferometric system limit the operation and performances of a cold-atom interferometer. A loss of contrast C is observed for example when all the atoms are detected on a point detector. This loss of contrast causes a loss of sensitivity of the atom interferometer. If the drop in contrast is significant, the interferometer will no longer function. More generally, in any case, the contrast is zero (C=0) when the atomic wave packets are no longer superimposed at the output of the atom interferometer. There exist methods known by the person skilled in the art to measure the contrast and follow a contrast reduction.

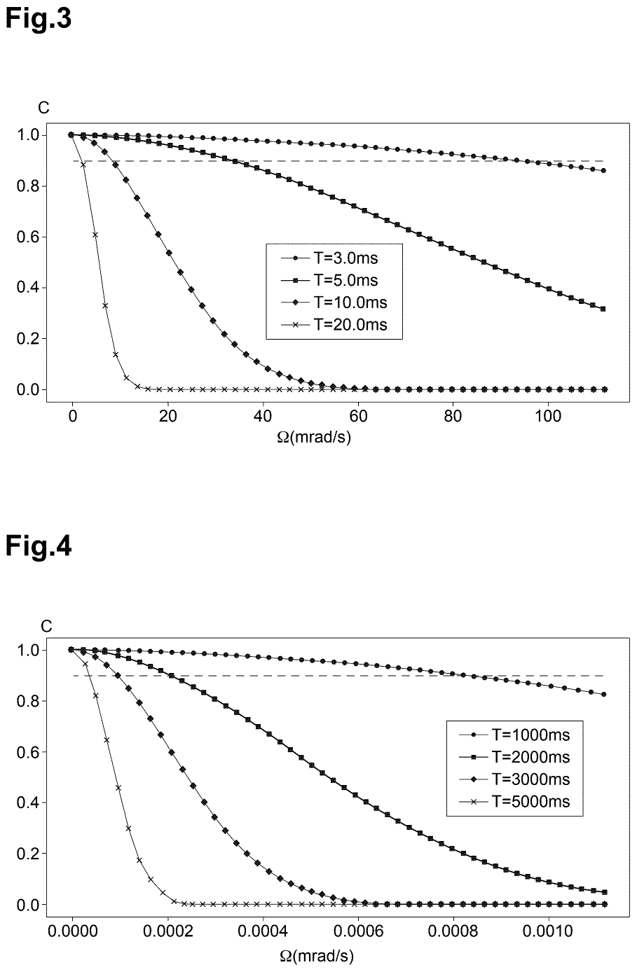

In the case of rotations, in particular, a change of orientation of the reflective surface of the optical component 5 during an interferometry sequence causes a reduction in the contrast C of the interferometry sequence when all the atoms are detected on a point detector. This contrast reduction is modelled by the following formula:

$$C \approx {exp ( - {k}_{eff} {σ}_{v} T )}^{2} {( Ω T )}^{2} ] \qquad [ Math . 1 ]$$

where k_{eff} represents the effective wave vector of the laser, σᵥ the speed distribution of the atom wave packet, T the interrogation duration of the interferometer and Ω the rotation rate of the experimental unit, comprising the experimental chamber 7 and the laser 6, about an axis transverse to the measurement axis. Such a behaviour is simulated in FIGS. 3 and 4. Depending on the target sensitivity domain, which is linked to the interrogation duration T, a relatively low rotation rate Ω can nevertheless lead to a total loss of contrast C of the measurement signal of the atom interferometer.

FIGS. 3 and 4 show simulation curves for the contrast C of the fringes of a cold-atom interferometer as a function of a rotation rate Ω transverse to the measurement axis of the atom interferometer, this rotation being not compensated, in an inertial navigation application (FIG. 3) and a spatial (FIG. 4) application, respectively. The curve in dashed line corresponds to a loss of contrast of 10% with respect to the maximum contrast C=1. This curve makes it possible to show that low rotation rates are enough to damage the interferometric measurement according to the interrogation time.

In an inertial navigation application (FIG. 3), the rotation rate (2 transverse to the measurement axis is for example included in a range of between 0 and 100 mrad/s (this range being by no means limiting, but being chosen here for the sake of clarity of explanation). In FIG. 3 are shown various curves corresponding to different interrogation durations T of an atom interferometry sequence: 3.0 ms (disc-shape markers), 5.0 ms (squares), 10.0 ms (diamonds) and 20.0 ms (crosses). For an interrogation duration of 3.0 ms, it is observed that the atom interferometer can operate with a limited loss of contrast (i.e. staying above the contrast C=0.9) up to a transverse rotation rate of about 93 mrad/s. For an interrogation duration of 5.0 ms, the limit transverse rotation rate is of about 34 mrad/s. For an interrogation duration of 10.0 ms, the limit transverse rotation rate is of about 8 mrad/s. For an interrogation duration of 20.0 ms, the limit transverse rotation rate is of about 2 mrad/s. Therefore, a very fast reduction in the contrast is observed as the interrogation duration increases.

In a spatial application (FIG. 4), the rotation rate Q transverse to the measurement axis is for example included in a range of between 0 and 0.0010 mrad/s (this range being by no means limiting, but being chosen here for the sake of clarity.). In FIG. 4 are shown various curves corresponding to different interrogation durations T of an atom interferometry sequence: 1000 ms (discs), 2000 ms (squares), 3000 ms (diamonds), 5000 ms (crosses). For an interrogation duration of 1000 ms, it is observed that the atomic interferometer can operate with a limited loss of contrast (i.e. staying above the contrast C=0.9) up to a transverse rotation rate of about 0.0008 mrad/s. For an interrogation duration of 2000 ms, the limit transverse rotation rate is of about 0.0002 mrad/s. For an interrogation duration of 3000 ms, the limit transverse rotation rate is of about 0.0001 mrad/s. For an interrogation duration of 5000 ms, the limit transverse rotation rate is of about 0.00005 mrad/s. Here again, a very fast reduction in the contrast C is observed as the interrogation duration increases.

Indeed, as schematically illustrated in FIG. 5, it is supposed that the unit formed by the experimental chamber 7, the optical component 5 and the plate 4 undergoes a rotation of its measurement axis by a rotation angle θ with respect to the external inertial reference frame at each interrogation duration T of an interferometry sequence “π/2−π−π/2”. For the sake of clarity of explanation, we will consider the particular case of rotation at constant rate for the interferometry sequence duration. Between time instant t=0 of the first pulse 21 and time instant t=T of the second pulse 22 of the interferometry sequence, the mobile reference frame is thus rotated by an angle θ with respect to the external inertial reference frame. In the same way, between time instant t=T of the second pulse 22 and time instant t=2T of the last pulse 29 of the interferometry sequence, the moving reference frame has been rotated by an angle θ with respect to the external inertial reference frame. Between the initial time instant t=0 and time instant t=2T, the moving reference frame has thus been rotated by an angle 2θ. In FIG. 6, it is observed that, at time instant t=2T, the two atom packets 31 and 32 are not spatially superimposed due to the rotation angle 2θ of the measurement axis. This explains the loss of contrast C of the atom interferometry fringes. A partial superimposition of the two atom packets 31 and 32 at time instant t=2T results in a reduction of the contrast C with respect to the maximum theoretical value C=1, when all the atoms are detected on a point detector. Using a camera, spatially resolved interferometry fringes can be detected. However, if the wave packets 31 and 32 are fully separated from each other, the contrast is strictly zero (C=0).

More generally, the rotation rate undergone by the interferometer can be random and even variable during the interferometry sequence. In this case, we can have a rotation of angle θ₁ before the second pulse 22 and a rotation of angle θ₂ between the second pulse 22 and the third pulse 23, with θ₂ different from θ₁.

FIG. 6 shows a perspective view of the same interferometry sequence as in FIG. 5. The paths of both atom packets 31 and 32 are represented in solid line. The projection of the paths of the atom packets 31 and 32 in planes (Y, t) and (Z, t) are represented in dashed lines. It is also observed that the paths of both atom packets 31 and 32 are not fully superimposed at time instant t=2T, due to the rotation 22 about any axis, as long as this rotation has a component transverse to the measurement axis.

On the other hand, a rotation of the inertial frame of reference about its measurement axis has no effect on the contrast of the atom interferometry measurements.

The present disclosure proposes to measure and compensate in real time, during a sequence of pulses, for the effects of a rotation about any axis transverse to the interferometric measurement axis.

For that purpose (see FIGS. 1-2), the plane retro-reflective optical component 5 is mounted on a plate 4. The plate 4 is mechanically rigidly connected to the experimental chamber 7. Laser 6 is also attached to the vacuum chamber 7. An actuating device 13, 14 mechanically connects the optical component 5 to the plate 4. The actuating device 13, 14 comprises for example one or two piezoelectric actuators. The actuating device 13, 14 makes it possible to tilt the optical component 5 with respect to the plate 4, i.e. with respect to the inertial frame of reference. An orthonormal coordinate system XYZ linked to the inertial frame of reference is considered. Preferably, the orthonormal coordinate system of the inertial frame of reference comprises the laser axis and two axes X and Y orthogonal to the laser axis, X-axis being orthogonal to Y-axis.

At the beginning of each interferometry sequence, the laser axis and the measurement axis (i.e. the normal to the surface of the optical component 5) are aligned with each other. Optionally, in particular in the case of a gravimeter or gradiometer, the measurement axis \vec{u_{M}} is aligned along a local vertical axis before the beginning of the interferometry sequence.

The actuating device 13, 14 is chosen to be able to direct the optical component 5 with high accuracy, high stability and wide bandwidth. For example, a first piezoelectric actuator 13 makes it possible to tilt the optical component 5 by rotation or pivoting about a first axis of rotation transverse to the laser axis \vec{u_{L}}. Advantageously, a second piezoelectric actuator 14 makes it possible to tilt the optical component 5 by rotation or pivoting about a second axis of rotation transverse to the laser axis \vec{u_{L}} and transverse to the first axis of rotation. The measurement axis \vec{u_{M}} pivots at the same time as the optical component 5. Advantageously, the first axis of rotation is orthogonal to the second axis of rotation. Initially, the measurement axis \vec{u_{M}} and the laser axis \vec{u_{L}} are orthogonal to the first axis of rotation and to the second axis of rotation. However, the detector 17 remains integral with the chamber 7 and thus with the rotating reference frame. Only the mirror rotates thanks to the compensation system.

In an example of inertial navigation application, actuators 13, 14 are chosen with a resolution of the order of micro-rad in closed loop and of the order of a hundred nano-rad in open loop. The repeatability of the actuators is of the order of micro-rad and the bandwidth is of the order of kHz. The angular dynamics is of the order of 35 mrad. The person skilled in the art adapts the choice of the actuators according to the needs to enhance one/more of these technical characteristics, sometimes to the detriment of one/more of the others. In an example of application in the spatial field, the order of magnitude of these ranges of values is generally divided by 100.

Interest is focused in particular on an application of the atom interferometer 100 to a measurement of acceleration along an acceleration axis denoted \vec{a}. In FIG. 1, the acceleration vector \vec{a} represents the total vector of acceleration that is applied to the atoms 8 in the experimental chamber 7. FIG. 1 is a simplified view projected in two dimensions, for a better understanding. This total vector of acceleration \vec{a} is the sum of the gravity g at the local point and of the other accelerations undergone by the atoms 8 in the experimental chamber 7. Therefore, the total acceleration vector \vec{a} can have a random orientation in space. The atom interferometer 100 measures a projection of the acceleration vector \vec{a} on the measurement axis \vec{u_{M}} that is normal to the reflective surface of the optical component 5.

The interferometric system 100 further includes at least one rotation sensor 1, 2 attached to the inertial frame of reference, for example to the plate 4. As an alternative, the at least one rotation sensor 1, 2 is attached to the experimental chamber 7. As in the example illustrated in FIG. 1, the interferometric system 100 comprises for example a first gyroscope 1 arranged and configured to acquire a measurement of rotation rate Ω_{X} of the plate 4 about a first axis X transverse to the laser axis \vec{u_{L}} and a second gyroscope 2 arranged and configured to acquire a measurement of rotation rate Ω_{Y} of the plate 4 about a second axis Y transverse to the laser axis \vec{u_{L}}. It is to be noted here that the laser axis \vec{u_{L}} remains fixed with respect to the plate 4 et the gyroscopes 1 and 2. The plate 4 being fixed with respect to the experimental chamber, each rotation sensor 1, 2 thus makes it possible to measure a rotation of the experimental chamber about an axis transverse to the measurement axis. Particularly advantageously, the gyroscopes 1, 2 are fiber-optic gyroscopes that have high sensitivity, accuracy and dynamic range. By way of non-limiting example, the gyroscopes 1, 2 have a sensitivity of the order of 100 nrad/s/√Hz, an accuracy of the order of 5 urad/s and a dynamic range higher than 0.1 rad/s.

As illustrated in FIGS. 1 and 2, the first gyroscope 1 transmits to the electronic system 3 the measurement of rotation rate Ω_{X} about the first axis X and, respectively, the second gyroscope 2 transmits to the electronic system 3 the measurement of rotation rate Ω_{Y} about the second axis Y. The electronic system 3 acquires at least one rotation rate measurement on each gyroscope at each interrogation duration T of a sequence.

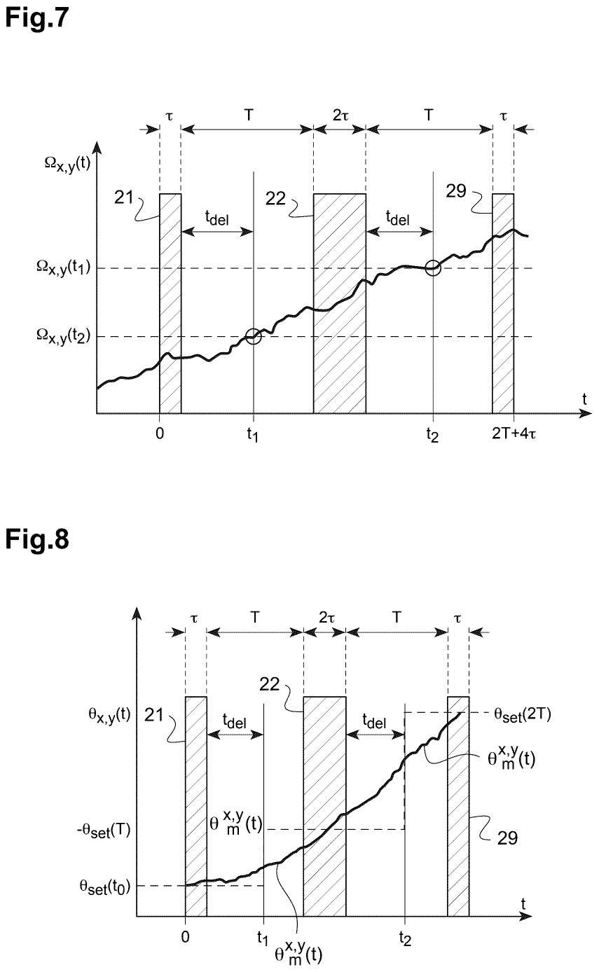

For example, as illustrated in FIG. 7, for each axis X or Y, the electronic system 3 acquires the rotation rate Ω_{X,Y}(t) of one of the gyroscopes 1, 2 as a function of time t over an interferometry sequence. The rotation rate Ω_{X,Y}(t) varies slowly during a sequence. Generally, the present disclosure applies for a rotation rate Ω_{X,Y}(t) varying in any way during an interferometry sequence. For the sake of clarity of explanation, a simplified example is considered, in which the rotation rate Ω_{X,Y}(t) varies linearly over the considered duration of interrogation. For each interrogation duration T of an interferometry sequence, the electronic system 3 receives at least one rotation rate measurement, preferably for each axis X, Y. Therefore, during the first interrogation duration T of an interferometry sequence, the electronic system 3 receives a measurement of rotation rate Ω_{X,Y}(t₁) at a time instant t₁ located between the first laser pulse 21 and the second laser pulse 22. Likewise, during the second interrogation duration T of the same interferometry sequence, the electronic system 3 receives a measurement of rotation rate Ω_{X,Y}(t₂) at a time instant t₂ located between the second laser pulse 22 and the last laser pulse 29. Time instant t₁, respectively t₂, is located for example at a duration t_{del} after the end of the first pulse 21, respectively of the second laser pulse 22. The duration t_{del} is lower than the interrogation duration T. The duration t_{del} represents an adjusted delay to find the best compromise between the time instant located exactly between two successive pulses (best estimation of the average) and a sufficient duration before the following pulse to stabilize the orientation of the mirror 5, given the response time of the actuators. For example, for an interrogation duration T equal to 10 ms, a time t_{del}=2.5 ms is used.

As illustrated in FIG. 8, the electronic system 3 integrates these measurements of rotation rate Ω_{X,Y}(t) as a function of time, to deduce therefrom a measurement of rotation angle

$${θ}_{m}^{X , Y} ( t )$$

of the inertial name of reference, as a function of time t, about the first axis X or, respectively, of the second axis Y, with respect to its position at the initial time instant t₀=0 of the interferometry sequence. The solid-line curve represents the rotation of the frame of reference in the inertial reference frame. Advantageously, these measurements are carried out in parallel for the two axes X and Y of gyroscopes 1 and 2. Thus, for each axis, the electronic system 3 calculates an evaluation of the rotation angle θ of the inertial frame of reference at time instant t=T+2τ of the second pulse as a function of the rotation rate measurement(s) between the first pulse 21 and the second pulse 22. This evaluation can be based on a time integration over the interrogation duration T.

In the particular simplified case of a linear approximation of the rotation rate Ω_{X,Y}(t) over the interrogation duration T, the angle of rotation θ can be calculated based on a single measurement of rotation rate Ω_{X,Y}(t₁) that, once integrated over the whole interrogation duration T, gives an angle that can be extrapolated as the angle of rotation for this duration. The set point of the angle of rotation

$${θ}_{set}^{X , Y} ( {T}_{} )$$

to be applied to optical component 5 before the second pulse 22 is calculated with respect to its initial position defined by an angle

$${θ}_{set}^{X , Y} ( {t}_{0} )$$

at time instant t₀=0 of the interferometry sequence, i.e. at the beginning of the first laser pulse 21. In the example shown in FIG. 8, the angle of rotation

$${θ}_{set}^{X , Y} ( {T}_{} )$$

is applied to the actuators of the mirror 5 from time instant t₁ to time instant t₂. The angle of rotation

$${θ}_{set}^{X , Y} ( {T}_{} )$$

applied is equal in absolute value and of opposite sign to Ω_{X,Y}(t₁).T. Similarly, the electronic system 3 calculates an evaluation of the rotation angle θ of the inertial frame of reference at time instant t=2T of the last pulse as a function of the rotation rate measurement(s) between the second pulse 22 and the last pulse 29. In the particular simplified case of a linear approximation of the rotation rate Ω_{X,Y}(t) over the interrogation duration T between the second pulse 22 and the last pulse 29, the angle of rotation θ can be calculated from a single measurement of rotation rate Ω_{X,Y}(t₂) at time instant t₂, this measurement being extrapolated over the interrogation duration T. The set point for the angle of rotation

$${θ}_{set}^{X , Y} ( 2 {T}_{} )$$

to be applied to the optical component 5 is calculated with respect to its angular position

$${θ}_{set}^{X , Y} ( T )$$

at the time of the second laser pulse 22 of the same interferometry sequence. In the example shown in FIG. 8, the angle of rotation

$${θ}_{set}^{X , Y} ( 2 T )$$

is applied to the actuators of the mirror 5 from the time instant t₂ to the end of the interferometry sequence. The angle of rotation

$${θ}_{s e t}^{X , Y} ( 2 {T}_{} )$$

applied is equal in absolute value and of opposite sign to Ω_{X,Y}(t₂).T. Two successive angle jumps are thus made during the same interferometry sequence.

In order to physically compensate for the effect of these rotations, the electronic system 3 applies to the piezoelectric actuators 13, 14 an angle of rotation

$${θ}_{set}^{X , Y} ( T )$$

from time instant t₁, and respectively an angle of rotation

$${θ}_{set}^{X , Y} ( 2 T )$$

from time instant t₂, of same amplitude and opposite sign to the angle

$${θ}_{m}^{X , Y}$$

calculated during the first interrogation duration, and respectively the last interrogation duration. More precisely, the angle of rotation θ is compensated for before application of the second pulse 22. Likewise, the angle of rotation θ is compensated for before application of the last pulse 29. The opposites of the set points

$${θ}_{set}^{X , Y} ( T ) et {θ}_{set}^{X , Y} ( 2 T )$$

are shown in dotted lines in FIG. 8 and are relative to the last angular position: the mirror is initially aligned with the laser, then pivoted by

$${θ}_{set}^{X , Y} ( T )$$

during the interrogation duration between the two first pulses and finally by

$${θ}_{set}^{X , Y} ( 2 T )$$

during the interrogation duration between the two last ones, than brought back in its reference orientation after the interferometry sequence (aligned with the laser).

Thus, the electronic system 3 makes it possible to compensate for the rotations undergone by the interferometric system 100 in real time, i.e. for each interrogation duration of a laser pulse sequence.

Of course, it is possible to acquire several rotation rate measurements on each axis X, Y for each interrogation duration T, and according to the response time of the electronic system and of the actuators, to calculate more accurately the angle of rotation to be applied before each successive laser pulse 22, 29 to compensate in real time for the rotations of the inertial frame of reference, in particular when the hypothesis of linearity of the rotation rate does not apply.

Generally, for an interferometry sequence comprising N successive laser pulses, at least one rotation angle measurement is acquired in each interrogation duration Tᵢ between pulse i−1 and pulse i, successively for each value of i=2, . . . , N. Before each pulse i, the angle of rotation θᵢ over the interrogation duration between pulse i−1 and pulse i is evaluated as a function of the at least one rotation rate measurement acquired between pulse i−1 and pulse i. Before each pulse i, a rotation angle set point is successively applied to the considered actuator so as to compensate for the rotation angle θi over the interrogation duration Tᵢ.

The choice of the time instant where the actuators exert a rotation is generally dictated by the technical characteristics of the actuators. In an example, the actuators apply a rotation shortly after pulse i−1, for example after a duration of 2.5 ms for an interrogation duration T equal to 10 ms. In another example, the actuators exert the rotation at time instant t=T/2 between two successive pulses or also just before pulse i. As an alternative, the actuators apply a rotation successively several times between two successive laser pulses. The important point is that the angle of rotation θ of the experimental chamber 7 accumulated between two successive laser pulses, respectively i−1 and i, are corrected at best at the moment when pulse i is operated, i.e. at the moment when the laser and the atoms interact together.

For example, an interferometer is considered, which has a three-pulse interferometry sequence “π/2-π-π/2”. That way, at each time instant t of an atom interferometer sequence, t being between t₀=0 and t=2T+4τ, the signals from the gyroscopes 1, 2 are integrated as a function of time to provide the new angle of inclination of the reference mirror 5 according to the following equation.

$${θ}_{m} ( t + dt ) = {θ}_{m} ( t ) - dt \cdot ( \begin{matrix}{Ω}_{X} \\ {Ω}_{Y} \\ {Ω}_{Z}\end{matrix} ) \qquad [ Math . 2 ]$$

where Ω_{X} represents the rotation rate measured by the first gyroscope 1 about the X-axis, Ω_{Y} represents the rotation rate measured by the second gyroscope 2 about the Y-axis, and Ω_{Z} represents the rotation rate about the Z-axis, optionally measured by a third gyroscope. The vector θₘ is the vector opposite to the rotation of the experimental chamber 7, i.e. the temporally integrated rotation rate vector. The Z-axis is merged with the measurement axis. It is however noted that the rotations about the measurement axis are not involved in the loss of contrast or in the correction of the mirror 5 orientation. Moreover, the duration t of the laser pulses is generally negligible with respect to the interrogation duration T.

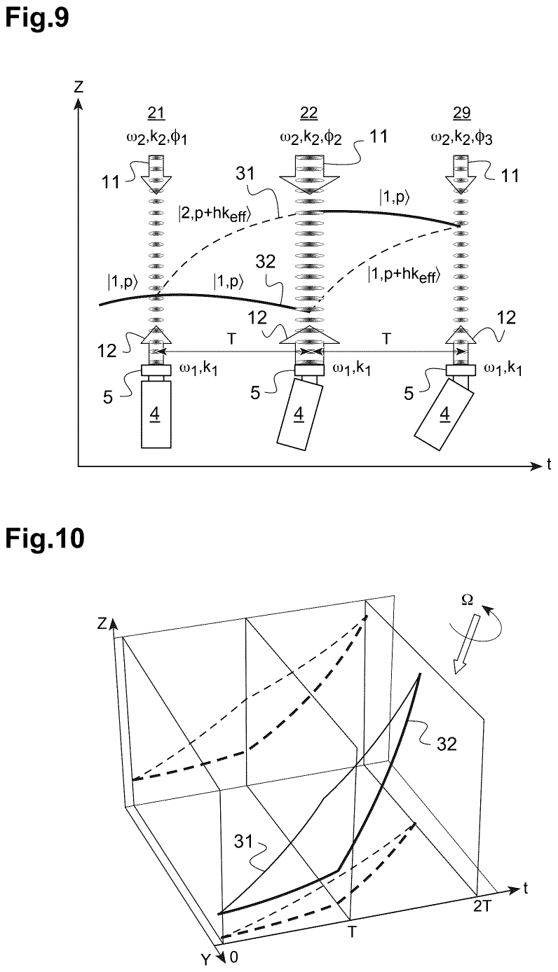

From this rotation vector of the experimental chamber 7, the algorithm of the FPGA 3 determines an associated matrix of rotation angle θ to be applied to the vector k defining the normal to the surface of the optical component 5, so as to align this vector k with its initial position at time instant to of the sequence. The vector k is here identical to k_{eff} or to the measurement axis \vec{u_{M}}. In other words, as schematically illustrated in FIGS. 9 and 10, this compensation for rotations of the measurement axis transverse to this axis makes it possible to obtain a better spatial overlap of the atom wave packets at the end of the interferometry sequence, and thus to increase the fringe contrast. The interferometric system thus makes it possible to solve the technical problem of loss of contrast induced by rotation of the experimental chamber 7 with respect to the inertial reference frame.

In an example of application, after compensation for rotations according to the present disclosure, a contrast C of 97% of its maximum value (without rotations) is obtained for T=10 ms and respectively of 95% of its maximum value (without rotations) is obtained for T=15 ms for a rotation rate of between 150 and 200 mrad/s.

As an option, and particularly advantageously, the optical component 5 and/or the piezoelectric actuators 13, 14 include a servo-control device equipped with orientation sensors that make it possible to measure the real angle

$${θ}_{real}^{X}$$

about the first axis, respectively

$${θ}_{real}^{Y}$$

about the second axis, of the optical component 5 with respect to the rotation angle set point

$${θ}_{set}^{X}$$

about the first axis, respectively

$${θ}_{real}^{Y}$$

about the second axis. The electronic system 3 can then efficiently servo-control in real time the position of the optical component 5 as a function of the rotations undergone by the inertial frame of reference.

As an option, a conventional inertial sensor 9 is fixed to the plate 4. The conventional inertial sensor 9 is arranged in such a way as to be sensitive to an acceleration or rotation about its measurement axis denoted \vec{u_{C}}. The angle formed between the axis \vec{u_{C}} of the conventional inertial sensor 9 and the axis of the acceleration vector \vec{a} is denoted γ.

Advantageously, the atom interferometer 100 being used in an application to measurements of acceleration or gravity, the conventional inertial sensor 9 includes an accelerator for measuring the acceleration along the axis \vec{u_{C}}. As an alternative, the conventional inertial sensor 9 includes three accelerometers arranged so as to measure the acceleration along three orthonormal axes. As an alternative or a complement, the conventional inertial sensor 9 comprises a third gyroscope to measure the rotation about the axis \vec{u_{C}}.

According to another alternative, the atom interferometer 100 is used in an application to measurements of rotation about the axis \vec{u_{M}} and the third conventional inertial sensor 9 comprises an accelerometer and/or a third gyroscope to measure the acceleration, respectively the rotation with respect to the measurement axis \vec{u_{C}} of the conventional inertial sensor 9.

The conventional inertial sensor 9 being fixed to the plate 4 that is rigidly attached to the vacuum chamber 7, the initial angle β between the laser axis \vec{u_{L}} and the measurement axis \vec{u_{C}} of the conventional initial sensor 9 is known. The initial angle α between the measurement axis of the atom interferometer \vec{u_{M}} and the laser axis \vec{u_{L}} is also known.

The measurements of the conventional inertial sensor 9 are not used for mirror 5 compensation. Advantageously, the conventional inertial sensor 9 is used to hybridize the measurements of the atom interferometer and the conventional measurements of acceleration and rotation from the conventional inertial sensor 9 as described in the patent FR 1751457. For example, the measurements of the conventional inertial sensor 9 are used to determine the fringe of interference corresponding to the measurement of acceleration via the atom interferometer. The measurements of the conventional inertial sensor 9 are also used to correct a phase shift due to vibrations.

According to the present disclosure, the phase-shift correction further includes, especially within the framework of rotation correction, the Coriolis phase shift and misalignments detailed below. Indeed, a Coriolis acceleration is an acceleration induced by the interaction between the atoms falling in straight line under the effect of gravity with respect to the inertial reference frame (of the laboratory, geocentric, in any case a fixed reference frame that does not undergo the inertial effects) and the mirror 5 that turns with respect to this same inertial reference frame. In this context, an acceleration induced by the rotation of the vacuum chamber 7 with respect to the inertial reference frame is observed, because the mirror undergoes the rotation rate, and another acceleration induced by the rotation of the mirror with respect to the chamber. This is why, within the context of the present disclosure, the phase correction corresponds to a Coriolis acceleration induced by a residual rotation rate (zero if the rotation of the mirror perfectly compensates for that of the chamber).

According to a particular and interesting aspect of the present disclosure, a phase term introduced both by the rotations of the vacuum chamber 7 and by the angular compensation of the mirror 5 is calculated in real time. For that purpose, let's consider the movements of the atoms, for example by falling in straight line in the inertial reference frame, with respect to the vacuum chamber 7, itself in rotation with respect to the inertial reference frame. The Coriolis term, defined by the following equation, is involved in the acceleration measurement:

$${a}_{Coriolis} = 2 {Ω}_{m} Λ {v}_{at} \qquad [ Math . 3 ]$$

where Ωₘ represents the real rotation rate vector of the mirror 5 in the inertial reference frame and Vat the speed of the atom wave packets. Ωₘ corresponds to a residual rotation rate of the mirror resulting from the rotation of the chamber from which the applied compensation is subtracted.

Using a sensitivity function formalism, the phase shift Φ_{Omega} induced by this Coriolis acceleration a(t) is determined. Assuming negligible pulse duration, this phase shift can be approximated by the following equation:

$${Φ}_{Omega} \approx - T {\int }_{- T}^{+ T} [ {k}_{eff} \times ( v ( t ) + ( T - t ) a ( t ) ) ] \cdot 2 {Ω}_{m} ( t ) dt \qquad [ Math . 4 ]$$

where v(t) represents the integral of a(t), i.e. the speed of the mirror relative to the atoms. When measuring the phase at the atom interferometer output, this phase shift is subtracted in order to prevent fringe blurring. It is a random phase term, which corresponds to measurement noise if no correction for this effect is done. Fringe blurring phenomenon is a problem that is uncorrelated with the loss of contrast; it is possible to avoid the loss of contrast while still having completely blurred fringes.

This formula is calculated for an interferometry sequence defined on an interval [−T; T]. This formula is valid with and without correction, using for the rotation rate Ωₘ(t):
Ωₘ(t)=Ω_{ch}(t) without angular correction of the mirror 5 and
Ωₘ(t)=Ω_{ch}(t)−Ω_{cor}(t) with angular correction of the mirror 5, where
Ω_{ch}(t) represents the rotation rate of the vacuum chamber and Ω_{cor}(t) represents the correction applied to the mirror 5. Thus, when the orientation of the mirror 5 is corrected, the rotation rate considered corresponds to a residual rotation rate due to an imperfect correction. The phase shift induced by the Coriolis acceleration is calculated in real time. There are several ways of adjusting the optical phase of the laser source, but it seems quicker and simpler to communicate the final value of the phase shift accumulated during the interferometry sequence only once, before the last pulse.

Other effects can be taken in consideration when rotations are compensated. In particular, the angular orientation of the optical component 5 with respect to the laser axis during an atom interferometry sequence causes several misalignments. The angle between the measurement axis \vec{u_{C}} of the conventional inertial sensor 9 and the acceleration vector \vec{a} (see FIG. 1) is denoted γ. The angle β between the laser axis \vec{u_{L}} and the measurement axis \vec{u_{C}} of the conventional inertial sensor 9, and the angle α between the measurement axis of the atom interferometer \vec{u_{M}} and the laser axis \vec{u_{L}}. The phase shift induced by this misalignment of the optical component 5 with respect to the laser axis is expressed as follows, in the approximation in which α, β<<1.

$${Φ}_{Misalignment} = {k}_{eff} a {T}^{2} ( α ( 2 T ) - β ) sin ( γ ( 2 T ) ) \qquad [ Math . 5 ]$$

The interferometric system makes it possible to realign the reference optical component 5 with respect to its initial position between each interferometry sequence. This system thus makes it possible to avoid a loss of contrast in the interferometric signals measured. It thus allows atom interferometry measurements to be carried out in a mobile environment subject to randomly variable rotations, without the need for a complex and cumbersome stabilisation system.

Moreover, the system makes it possible to reconstruct the atom interferometry fringes in real time during a sequence and to correct the laser phase before the last pulse of an interferometry sequence in such a way that the total phase at the end of the interferometry sequence takes this term into account.

This correction can advantageously be added to a hybridization scheme as described in the patent document WO 2018/154254 A1, to allow simultaneously compensating for the vibrations and rotations. For that purpose, the conventional inertial sensor 9 comprises a third gyroscope to measure the rotation about the axis \vec{u_{C}}. The third gyroscope is based on a MEMS or laser gyroscope or fiber-optic gyroscope technology. This double correction makes it possible for the refocusing or monitoring of the central fringe of the interferogram to be preserved.

Of course, various other modifications can be made to the invention within the scope of the appended claims.

1-11. (canceled)

12. A cold-atom and light-pulse interferometric system, the interferometric system comprising a vacuum chamber, a laser source, a plane retro-reflective optical component, an electronic system and a detection system, the vacuum chamber being adapted to contain a cloud of cold atoms, the laser source being adapted to generate a sequence of laser pulses towards the cloud of cold atoms along an axis of the laser (u_{L}), the retro-reflective optical component being arranged so as to reflect the sequence of laser pulses towards the cloud of cold atoms, the sequence of laser pulses comprising N successive light pulses, where N is an integer number higher than or equal to three, the successive light pulses of the sequence being temporally separated from each other by an interrogation time T; the retro-reflective optical component having a normal to its plane defining a measurement axis aligned with laser axis at an initial time instant of the sequence; the electronic system and the detection system being configured to carry out an inertial measurement of the cloud of atoms, by atom interferometry, along the measurement axis,
wherein the interferometric system includes: an actuating device mechanically connecting the optical component to a plate, the plate being fixed with respect to the vacuum chamber, and at least one rotation sensor fixed with respect to the vacuum chamber, the at least one rotation sensor and the electronic system being suitable to provide at least one measurement of rotation of the vacuum chamber about at least one axis transverse to the laser axis at each interrogation time of said sequence, the electronic system and the actuating device being adapted to angularly tilt the optical component with respect to said plate during each interrogation time of said sequence, as a function of said at least one rotation measurement acquired by the rotation sensor during said interrogation time of said sequence, in order to compensate for a rotation of the vacuum chamber transversely to the laser axis at each successive light pulse of the sequence with respect to an orientation of the vacuum chamber at the initial time instant of the sequence.

13. The interferometric system according to claim 12, wherein the electronic system is adapted to adjust an optical phase of the laser source emitting the pulse sequence as a function of a measurement of the Coriolis acceleration induced by a compensating rotation of the optical component.

14. The interferometric system according to claim 12, wherein the actuating device comprises a first actuator adapted to tilt the optical component with respect to said plate about a rotation axis transverse to the laser axis and/or a second actuator adapted to tilt the optical component with respect to said plate about another rotation axis transverse to the laser axis.

15. The interferometric system according to claim 12, wherein the at least one rotation sensor comprises a first gyroscope adapted to acquire a measurement of the rotation rate (Ω_{X}) of the vacuum chamber about a first axis (X) transverse to the laser axis and/or a second gyroscope adapted to acquire a measurement of the rotation rate (Ω_{Y}) of the vacuum chamber about a second axis (Y) transverse to the laser axis.

16. The interferometric system according to claim 15, wherein the first gyroscope is a fiber-optic gyroscope, and the second gyroscope is a fiber-optic gyroscope.

17. The interferometric system according to claim 15, wherein the interrogation time is between 1 ms and several seconds, the first gyroscope and the second gyroscope being configured to acquire the rotation measurement.

18. The interferometric system according to claim 12, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.

19. The interferometric system according to claim 18, wherein the conventional sensor comprises a third gyroscope adapted to acquire a measurement of the rotation rate (Qz) of the plate about the laser axis.

20. Use of an interferometric system according to claim 12 to measure an acceleration or a rotation of the vacuum chamber.

21. A cold-atom and light-pulse interferometric method comprising the following steps:
generating a sequence of laser pulses towards a cloud of cold atoms in a vacuum chamber, the sequence of laser pulses comprising N successive laser pulses, where N is an integer number higher than or equal to three, the successive light pulses of the sequence being timely separated by an interrogation time T, the light pulses being reflected on a plane retro-reflective optical component, a normal to the plane of the retro-reflective optical component defining a measurement axis and being aligned to the laser axis at an initial time instant of the sequence;
at the end of the sequence of laser pulses, carrying out an inertial measurement of the cloud of atoms, by atom interferometry, along the measurement axis, the inertial measurement being integrated over the sequence of laser pulses;
measuring at least a rotation of the vacuum chamber about at least one axis transverse to the laser axis at each interrogation time of said sequence;
at each interrogation time, angularly tilting the optical component with respect to the vacuum chamber, as a function of the rotation measured during said interrogation time of said sequence, in order to compensate for a rotation of the vacuum chamber transversely to the laser axis at each successive light pulse of the sequence with respect to an orientation of the vacuum chamber at the initial time instant of the sequence.

22. The method according to claim 21, comprising the following steps: acquiring a measurement of the Coriolis acceleration induced by a compensation rotation of the optical component and adjusting an optical phase of the laser source emitting the sequence of pulses to compensate for the Coriolis acceleration measurement.

23. The interferometric system according to claim 13, wherein the actuating device comprises a first actuator adapted to tilt the optical component with respect to said plate about a rotation axis transverse to the laser axis and/or a second actuator adapted to tilt the optical component with respect to said plate about another rotation axis transverse to the laser axis.

24. The interferometric system according to claim 13, wherein the at least one rotation sensor comprises a first gyroscope adapted to acquire a measurement of the rotation rate (Ω_{X}) of the vacuum chamber about a first axis (X) transverse to the laser axis and/or a second gyroscope adapted to acquire a measurement of the rotation rate (Ω_{Y}) of the vacuum chamber about a second axis (Y) transverse to the laser axis.

25. The interferometric system according to claim 14, wherein the at least one rotation sensor comprises a first gyroscope adapted to acquire a measurement of the rotation rate (Ω_{X}) of the vacuum chamber about a first axis (X) transverse to the laser axis and/or a second gyroscope adapted to acquire a measurement of the rotation rate (Ω_{Y}) of the vacuum chamber about a second axis (Y) transverse to the laser axis.

26. The interferometric system according to claim 16, wherein the interrogation time is between 1 ms and several seconds, the first gyroscope and the second gyroscope being configured to acquire the rotation measurement.

27. The interferometric system according to claim 13, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.

28. The interferometric system according to claim 14, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.

29. The interferometric system according to claim 15, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.

30. The interferometric system according to claim 16, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.

31. The interferometric system according to claim 17, comprising a conventional sensor attached the plate, the conventional sensor comprising a first accelerometer adapted to acquire a measurement of acceleration of the plate along an axis transverse to the laser axis, a second accelerometer adapted to acquire a measurement of acceleration of the plate along another axis transverse to the laser axis and/or a third accelerometer adapted to acquire a measurement of acceleration of the plate along the laser axis, and wherein the electronic system is adapted to hybridize the measurements of the conventional sensor with the measurements of the interferometric system.
